(19) United States
(12) Patent Application Publication
(10) Pub. No.: US 2019/0247268 A1
(43) Pub. Date: Aug. 15, 2019

(54) FASCIA TISSUE FITNESS DEVICE

(71) Applicant: Ashley Diana Black International Holdings, LLC, Friendswood, TX (US)

(72) Inventor: Ashley D. Black, Friendswood, TX (US)

(73) Assignee: Ashley Diana Black International Holdings, LLC

(21) Appl. No.: 16/392,370

(22) Filed: Apr. 23, 2019

Related U.S. Application Data
(63) Continuation of application No. 14/188,143, filed on Feb. 24, 2014, now Pat. No. 10,322,057.
(60) Provisional application No. 61/768,250, filed on Feb. 22, 2013.

(51) Int. Cl. A61H 7/00; A61H 39/04

(52) U.S. Cl. CPC A61H 7/003; A61H 7/007; A61H 39/04; A61H 7/001; A61H 2205/10; A61H 2205/081; A61H 2205/06; A61H 2201/0153; Y10T 29/49826; A61H 2205/106; A61H 2205/12; A61H 2207/00; A61H 2201/1253

(57) ABSTRACT

A fascia tissue fitness device including a support member, at least one base member connected to and extending radially from the support member. Multiple finger members including a shaft having a base portion and a tip portion may extend from a side surface of the base member(s), where the finger members may be arced from the base portion to the tip portion so as to curve away from the base member(s) and the support member.

### RELATED APPLICATIONS

This application claims priority to co-pending U.S. patent application having Ser. No. 14/188,143, which claims priority to U.S. Provisional Application Ser. No. 61/768,250 filed Feb. 22, 2013, the contents of which are hereby incorporated by reference in their entirety.

### BACKGROUND

Fascia tissue is a layer of fibrous tissue that operates as a connective tissue that surrounds muscles, groups of muscles, nerves, blood vessels, etc. The tissue allows for proper functioning of muscles with respect to one another (e.g., sliding past one another). When fascia tissue becomes damaged through injury, tissue knots, medical reasons, or otherwise, the fascia tissue can take time to correct itself or require manipulation to release the fascia tissue and allow for proper functioning of the tissue to allow the underlying muscle to properly operate. In some cases, the fascia tissue can be released or corrected without much difficulty, while in other cases, restoring the fascia tissue to its proper form can take considerably more effort. Other reasons for releasing fascia tissue may include cosmetic reasons, especially for people who have dimpled skin, which is often caused by fascia tissue extending through fat cells, thus causing dimples to appear on the skin. Often, when the fascia tissue is properly released, the dimples can be considerably reduced or eliminated.

### SUMMARY

The principles of the present invention provide for a device configured to provide for fitness of fascia tissue. The device may include a bar along which “flower” members having a number of “finger” or “leg” members are fixedly positioned. In one embodiment, the bar may have handle regions at each end with a certain number, such as four, of flower members linearly positioned thereon. The bar and handle regions may be molded as a single piece of material. The handle regions may be defined by grippers formed of rubber or other material over the handle regions with protrusions to provide for additional gripping for a user. The handle regions may have the same or different circumference as the bar. The handle regions may be positioned about the width of human shoulders. The material of the flower members may be PVC, acrylic, or any other material that provides for rubbing across human skin without cutting or scratching. As a lubricant is generally used during usage of the device, a variety of different materials for the finger members may be utilized.

A fascia tissue fitness device may include a bar and multiple flower members connected to the bar along a plane. The flower members may each include multiple finger members that are stiff and extend outward from the bar.

One method of manufacturing a fascia tissue fitness device may include providing a bar, providing multiple flower members, and connecting the flower members to the bar.

A fascia tissue fitness device including a support member, at least one base member connected to and extending radially from the support member, the at least one base member extending from the support member and having a top surface and a side surface extending between the top surface and the support member, and (iii) multiple finger members each including a shaft having a base portion and a tip portion. The base portion of the finger members extending from the side surface of the base member(s) such that the base portion does not directly extend from the top surface of the base member(s). The shaft of the finger members may arc from the base portion toward the tip portion. The arc may include a concave contour that extends from the side surface of the base member to the tip portion of the finger members, and a convex contour that is opposite of the concave contour. The convex contour includes a curvature greater than a curvature of the concave contour, where the convex contour extends from the side surface of the base member(s) to the tip portion of the finger members, thereby forming finger members that curve away from the base member(s) and the support member.

A fascia tissue fitness device may include a singular, linear, and uniformly tubular bar. Multiple base members may be connected to and disposed in a co-planar configuration that extend radially from the singular, linear, and uniformly tubular bar. The base members may extend from the bar and have a top surface and a side surface extending between the top surface and the bar. Multiple finger members may each include a shaft having a base portion and a tip portion, the base portion of the finger members extend from the side surface of the base members such that the base portion does not directly extend from the top surface of the base members. The shaft of the finger members may form an arc that extends from the base portion toward the tip portion, where the arc may include a concave contour that extends from the side surface of the base member to the tip portion, and a convex contour that is opposite of the concave contour. The convex contour includes a curvature greater than a curvature of the concave contour. The convex contour extends from the side surface of the base members to the tip portion of the finger members, thereby forming finger members that curve away from the base members and the bar.

### BRIEF DESCRIPTION

A more complete understanding of the method and apparatus of the present invention may be obtained by reference to the following Detailed Description when taken in conjunction with the accompanying Drawings wherein:

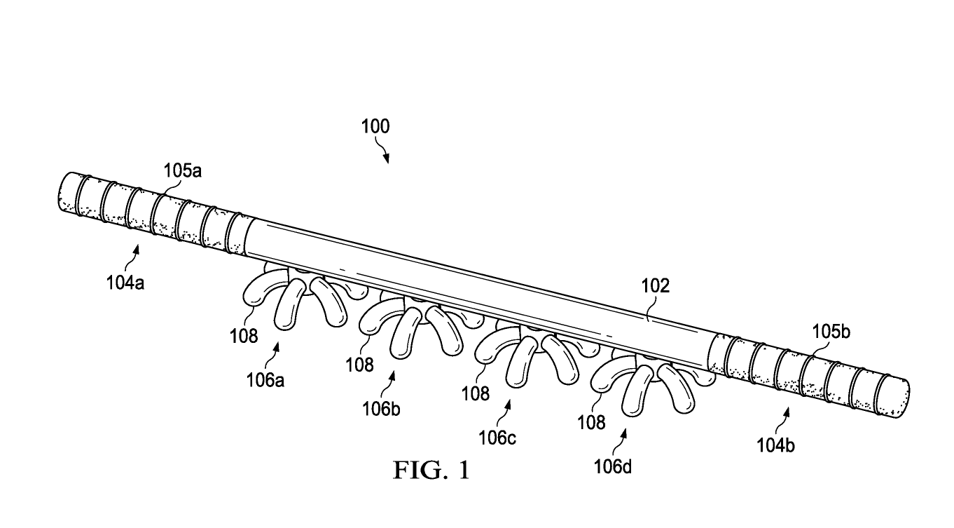

FIG. 1 is an illustration of a rear isometric view of an illustrative fascia tissue fitness device;

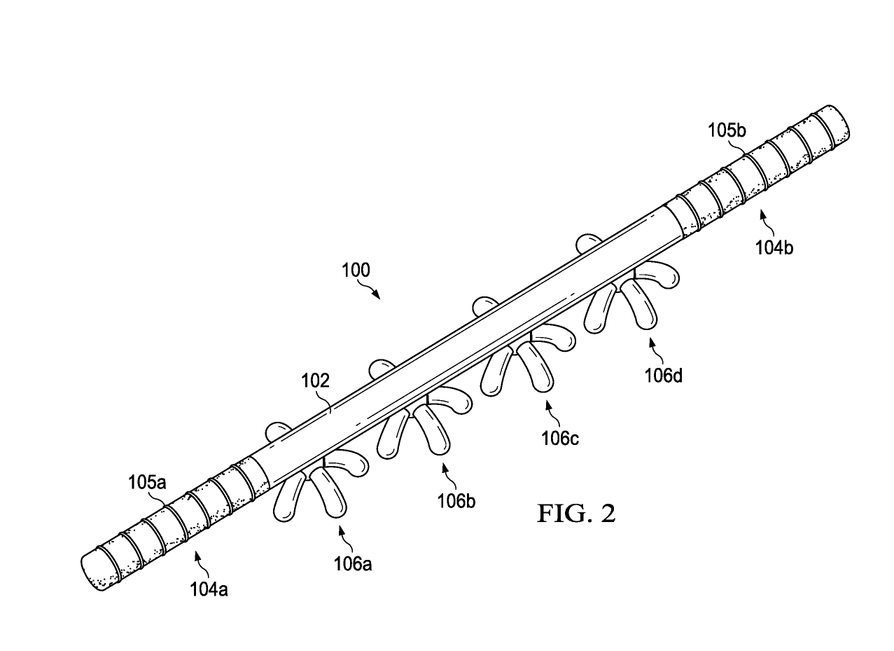

FIG. 2 is another illustration of a rear isometric view of the illustrative fascia tissue fitness device of FIG. 1;

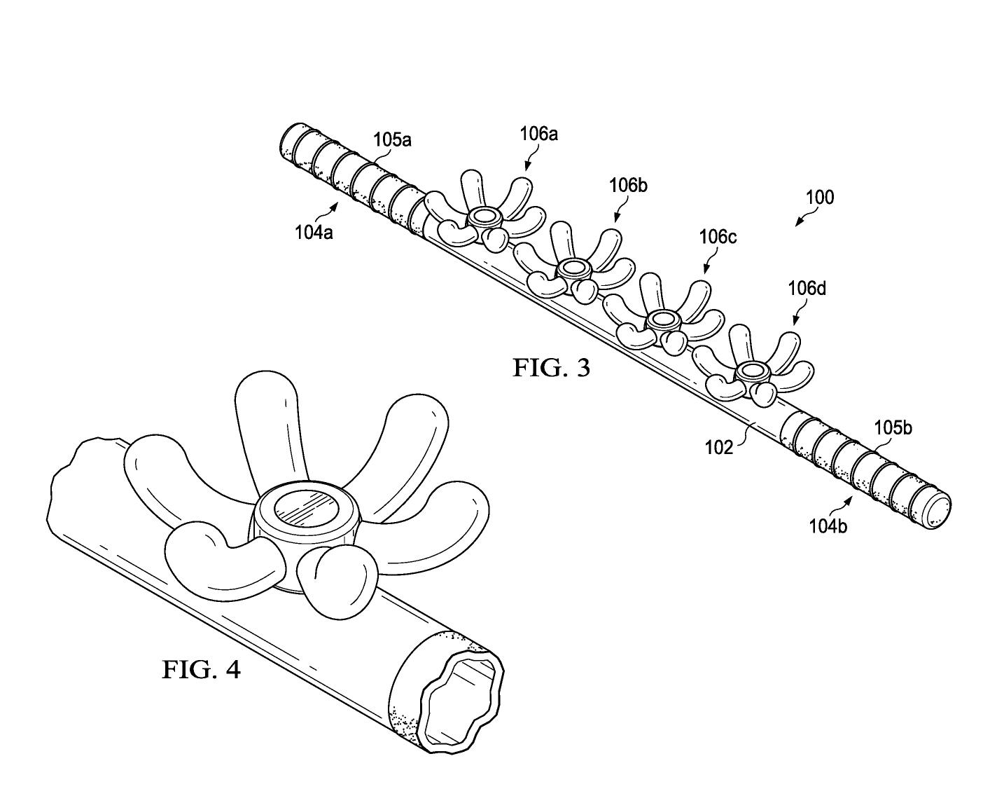

FIG. 3 is an illustration of a front isometric view of the illustrative fascia tissue fitness device of FIG. 1; and

FIG. 4 is an illustration of a close-up view of a “flower” member mounted to the bar of the illustrative fascia tissue fitness device of FIG. 1.

### DETAILED DESCRIPTION OF THE DRAWINGS

With regard to FIG. 1, an illustration of a rear isometric view of an illustrative fascia tissue fitness device 100 is shown. The device 100 may include a bar 102 having handle regions 104a and 104b (collectively 104). The handle regions 104 may have grippers 105a and 105b (collectively 105) formed or applied thereto. The grippers 105 may be formed of rubber or other material to provide gripping in a secure manner to prevent rotation of the bar 102. The handle regions 104 may have the same or different diameter as the bar 102. The length of the bar 102 may be such that the handle regions 104 are positioned about the distance of human shoulders (e.g., 30 inches). As such, there may be multiple lengths of the device 100. In one embodiment, the bar 102 may be extendible formed of one or more elements to be and use a variety of techniques for locking the element(s) to be a fixed length, thereby enabling people with different widths of shoulders to more easily use the device. As shown, however, the bar 102 and handle regions 104 are formed by a molding process that forms a single unit.

The bar 102 should be stiff or rigid, thereby minimizing bending during usages, such as self-usage. Although the bar 102 is shown to have a straight tube profile, it should be understood that alternative configurations of the bar 102 may be utilized in accordance with the principles of the present invention. For example, the bar may have a square profile, hexagonal profile, or another geometric or non-geometric profile. Still yet, the bar 102 may be curved, circular, oval, or otherwise to assist in better addressing different modalities and anatomical regions, such as backs, arms, calves, feet, and hands. In an alternative embodiment, rather than using a bar, a board (e.g., circular flat board) having flower members extending from one side of the board may be utilized in accordance with the principles of the present invention. To enable a user to use the board, a handgrip and/or hand strap connected to the board may be utilized in accordance with the principles of the present invention. Whether a support for the flower members 106 is in a bar, board, or other configuration, the principles of the present invention provide for the flower members 106 to be in a linear or non-linear alignment with respect to one another.

In one embodiment, and as shown, flower members 106a-106d (collectively 106) are shown to be mounted to the bar 102. The flower members 106 may be formed of acrylic, PVC, hard rubber, or any other material that is stiff and does not cut or scrape skin of a person on which the device 100 is being utilized to help treat or adjust fascia tissue. In the configuration of FIG. 1, there are four flower members. Alternative number of flower members may be utilized in accordance with the principles of the present invention. The flower members 106 are shown to be evenly spaced along a plane extending along the bar 102. Alternative spacing of the flower members 106 may be utilized in accordance with the principles of the present invention. The flower members 106 are also shown to be substantially identical. Alternative configurations of the flower members 106 may be utilized to provide for treating different size anatomical regions. It should be understood that a different number of flower members 106 may be utilized depending on the dimensions of the flower members 106 and other factors. In one embodiment, the bar 102 may have flower members 106 of different sizes so as to be available to treat different anatomical regions or different sized individuals. As an example, different sized flower members 106 may be positioned on opposite sides, for example of the bar 102 and facing away from one another to allow a single device to be used to treat the different anatomical regions and/or different sized individuals.

The flower members 106 shown are about 1½ inches in diameter. However, the diameter of the flower members 106 may have a fairly wide range (e.g., ½ inch to 4 inches in diameter). Illustrative finger members 108 shown are about ¾ of an inch long and have heads or tips that are about ⅜ of an inch across. The dimensions and configurations (e.g., curves) of the flower members 106, finger members 108, and tips of the finger members 108 may vary depending on the anatomical region on which the device 100 is to be used. The tips of the finger members 108 may have one or more same or different dimensions as the finger members (e.g., the tips may have a larger diameter by being bulbous). The finger members 108 are shown to be curved. Alternative configurations, such as finger members 108 being straight, may be utilized, as well. The flower members 106 are also shown to be a single member. However, flower members 106 may be formed of multiple elements. Still yet, rather than the device 100 using flower members 106 that have a flower-like appearance (i.e., central portion with extending finger members), flower members 106 with non-flower-like appearance may be utilized, as well, that still provides a user with a number of closely spaced pressure-point elements that can be pressed and guided along a person's skin to cause fascia tissue to be released or perform a non-therapeutic function. The finger members 108 may be substantially the same length (e.g., less than 0.1 inch difference in length between finger length) such that the tips of the finger members 108 are substantially co-planar so that a pressure load applied to the skin and fascia tissue is substantially equally applied by each of the finger members 108.

Each of the flower members 106 are shown to have six finger members 108. Alternative numbers of finger members 108 may be utilized in accordance with the principles of the present invention. The finger members 108 may be stiff or rigid, thereby having minimum bend or deformation during usage of the device on fascia tissue of a person. Although the flower members 106 are shown to extend along one side of the bar 102, additional flower members have the same or different configurations as the flower members 106 may be included to allow for a single device 100 to provide for different size and configuration of flower members to be used on different anatomical regions.

The bar 102 may have openings (not shown) defined by the bar 102 through which a screw or other fastening mechanism may extend through flower members 106 into the bar 102. After fastening the flower members 106 to the bar 102, glue or other fastening material, such as epoxy, may be utilized to secure the flower members 106 to the bar 102. A cover (not shown) above the fastening mechanisms may be utilized to limit the ability for someone to access or remove the fastening mechanisms of the flower members 106. Alternatively, the flower members 106 may be configured to allow for a user to more easily replace the flower members 106 to change size, replace broken flower members, or otherwise. Other attachments that may be flower members or non-flower members (e.g., roller) may also be connected to the bar 102 in accordance with the principles of the present invention.

FIG. 2 is another illustration of a rear isometric view of the illustrative fascia tissue fitness device 100 of FIG. 1.

FIG. 3 is an illustration of a front isometric view of the illustrative fascia tissue fitness device 100 of FIG. 1.

FIG. 4 is an illustration of a close-up view of a “flower” mounted to the bar of the illustrative fascia tissue fitness device of FIG. 1.

While certain features of the device 100 are configured to be optimal usage on fascia tissue, the features also provide for ornamental appearance. For example, the number of flower members 106, configuration of the bar 102, configuration of the handle regions 104, grippers 105, number of finger members 108 on the flower members 106, shape of the finger members 108, and so forth. As such, the overall and certain ornamental features are included in the device 102 in accordance with the principles of the present invention. It should be understood that utilizing the device 102 may be used for increasing overall myo-fascial fitness to loosen fascia tissue that is constrained, improve health and/or beauty purposes (e.g., provide a satisfactory feeling to a user and/or alter the appearance of cellulite and skin smoothness). Moreover, usage of the fascia tissue fitness device may open, loosen, restore, and/or revitalize fascia tissue of men and women, young and old.

The previous description is of a preferred embodiment for implementing the invention, and the scope of the invention should not necessarily be limited by this description. The scope of the present invention is instead defined by the following claims.

What is claimed:

1. A fascia tissue fitness device, comprising:
a support member;
at least one base member connected to and extending radially from the support member, the at least one base member extending from the support member and having a top surface and a side surface extending between the top surface and the support member; and
a plurality of finger members each including a shaft having a base portion and a tip portion, the base portion of the finger members extending from the side surface of the at least one base member such that the base portion does not directly extend from the top surface of the at least one base member, the shaft of the finger members forming an arc that extends from the base portion toward the tip portion, the arc including a concave contour that extends from the side surface of the base member to the tip portion, and a convex contour that is opposite of the concave contour and includes a curvature greater than a curvature of the concave contour, the convex contour extending from the side surface of the respective base member to the tip portion of the finger members, thereby forming finger members that curve away from the at least one base member and the support member.

2. The device according to claim 1, wherein the at least one base member is two in number.

3. The device according to claim 1, further comprising a grip region with a coating disposed thereon.

4. The device according to claim 3, wherein the grip region is disposed at the end of the support member.

5. The device according to claim 3, wherein the coating is rubber.

6. The device according to claim 1, wherein the at least one base member is cylindrical.

7. The device according to claim 1, wherein the support member is a singular, linear, and uniformly tubular bar.

8. The device according to claim 1, wherein the plurality of finger members is six in number.

9. The device according to claim 1, wherein each combination of base member and finger members is substantially identical to one another.

10. The device according to claim 1, wherein a length of the support member is about a width of human shoulders.

11. The device according to claim 1, wherein the shaft of the finger members are cylindrical.

12. The device according to claim 1, wherein the tips of the finger members are co-planar.

13. The device according to claim 1, further comprising at least one fastening mechanism, and wherein the support member defines at least one opening through which the at least one fastening mechanism extends through to secure the at least one base member to the support member.

14. The device according to claim 1, wherein each of a plurality of base members is the same size.

15. A fascia tissue fitness device, comprising:
a singular, linear, and uniformly tubular bar;
a plurality of base members connected to and disposed in a co-planar configuration that extend radially from the singular, linear, and uniformly tubular bar, the base members extending from the bar and having a top surface and a side surface extending between the top surface and the bar; and
a plurality of finger members each including a shaft having a base portion and a tip portion, the base portion of the finger members extending from the side surface of the base members such that the base portion does not directly extend from the top surface of the base members, the shaft of the finger members forming an arc that extends from the base portion toward the tip portion, the arc including a concave contour that extends from the side surface of the base member to the tip portion, and a convex contour that is opposite of the concave contour, and includes a curvature greater than a curvature of the concave contour, the convex contour extending from the side surface of the respective base member to the tip portion of the finger members, thereby forming finger members that curve away from the base members and the bar.

16. The device according to claim 15, wherein the base members are two in number.

17. The device according to claim 15, further comprising a grip region with a coating disposed thereon.

18. The device according to claim 17, wherein the grip region is disposed at the end of the support member.

19. The device according to claim 15, wherein the base members are cylindrical.

20. The device according to claim 15, wherein a length of the support member is about a width of human shoulders.
